(19) United States
(12) Patent Application Publication
(10) Pub. No.: US 2009/0303973 A1
(43) Pub. Date: Dec. 10, 2009

(54) PACKET DATA NETWORK SELECTION

(75) Inventor: Basavaraj Patil, Coppell, TX (US)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy, Espoo (FI)

(21) Appl. No.: 12/188,170

(22) Filed: Aug. 7, 2008

Related U.S. Application Data
(63) Continuation-in-part of application No. 12/136,501, filed on Jun. 10, 2008.

(51) Int. Cl. H04Q 7/24

(52) U.S. Cl. 370/338

(57) ABSTRACT

According to an example embodiment, a method may include sending, by a mobile station in a wireless network, a dynamic host configuration protocol (DHCP) message to a DHCP server via a base station. The DHCP message may identify a packet data network (PDN) by access point node (APN). The method may also include exchanging data with the indicated packet data network via the base station.

### PRIORITY CLAIM

This application is a continuation-in-part application of U.S. patent application Ser. No. 12/136,501, filed on Jun. 10, 2008, entitled, “Packet Data Network Selection,” the disclosure of which is hereby incorporated by reference.

### TECHNICAL FIELD

This description relates to wireless networks.

### BACKGROUND

Mobile stations may establish an air interface with a base station. The base station may be connected to one or more backhaul networks.

### SUMMARY

According to one example embodiment, a method may include sending, by a mobile station in a wireless network, a dynamic host configuration protocol (DHCP) message to a DHCP server via a base station, the DHCP message identifying a packet data network (PDN) by access point node (APN). The method may also include exchanging data with the indicated packet data network via the base station.

According to another example embodiment, an apparatus may include a controller, a wireless transceiver, and a memory. The controller may be configured to generate a dynamic host configuration protocol (DHCP) message, the DHCP message identifying a packet data network (PDN) by access point node (APN), and process data to be exchanged with the indicated packet data network via a base station. The wireless transceiver may be configured to send the DHCP message to the base station and to send and receive the data to and from the base station

According to another example embodiment, a method may include receiving, by a dynamic host configuration protocol (DHCP) server from a mobile station, a DHCP request message, the DHCP request message identifying a packet data network (PDN) by access point node (APN). The method may further include sending a trigger message to a proxy mobile Internet Protocol (PMIP) mobility access gateway (MAG) function, the trigger message including the APN. The method may further include receiving an acknowledgment from the PMIP MAG indicating that the identified PDN is available and authorized for the mobile node. The method may further include sending a DHCP acknowledgment to the mobile station.

According to another example embodiment, an apparatus may include a controller, a transceiver configured to send and receive messages, and a memory. The controller may be configured to process a dynamic host configuration protocol (DHCP) request message received via the transceiver, the DHCP request message identifying a packet data network (PDN) by access point node (APN) option, generate a proxy mobility Internet Protocol (PMIP) mobility access gateway (MAG) trigger message for the transceiver to send to a MAG function of an access service network (ASN) gateway, the PMIP MAG trigger message including the APN, and process an acknowledgment of the PMIP MAG trigger message received by the transceiver from the ASN gateway indicating that the identified PDN is available

According to another example embodiment, a method may include receiving, by an access service network (ASN) gateway from a dynamic host configuration protocol (DHCP) server, a proxy mobility Internet Protocol (PMIP) mobility access gateway (MAG) trigger message. The PMIP MAG trigger message may identify a packet data network (PDN) by access point node (APN). The method may also include determining that the identified PDN is available to communicate with a mobile station. The method may also include sending an acknowledgment of the PMIP MAG trigger message from the ASN gateway to the DHCP server indicating that the identified PDN is available. The method may also include sending a proxy binding update from the ASN gateway to a gateway associated with the identified PDN.

According to another example embodiment, an apparatus may include a controller, a transceiver configured to send and receive data, and a memory. The controller may be configured to process a proxy mobility access gateway Internet Protocol (PMIP) mobility access gateway (MAG) trigger message received via the transceiver from a dynamic host configuration protocol (DHCP) server, the PMIP MAG trigger message identifying a packet data network (PDN) by access point node (APN), determining that the identified PDN is available to communicate with a mobile station, generate an acknowledgment of the PMIP MAG trigger message for the transceiver to send to the DHCP server indicating that the identified PDN is available, and generate a proxy binding update for the transceiver to send to a gateway associated with the identified PDN

The details of one or more implementations are set forth in the accompanying drawings and the description below. Other features will be apparent from the description and drawings, and from the claims.

### BRIEF DESCRIPTION OF THE DRAWINGS

FIG. 1A is a diagram showing a wireless network, an access service network, evolved packet core networks, and packet data networks according to an example embodiment.

FIG. 1B is a diagram showing a mobile station receiving user input according to an example embodiment.

FIG. 1C is a diagram showing an access service network gateway and a dynamic host configuration protocol (DHCP) server according to an example embodiment.

FIG. 1D is a diagram showing an access service network gateway and a DHCP server according to another example embodiment.

FIG. 2A is a timing diagram showing establishment of a connection between a mobile station (MS) and a packet data network (PDN) gateway (GW) according to an example embodiment in which the access service network initiates service flow establishment.

FIG. 2B is a timing diagram showing establishment of a connection between the mobile station (MS) and the packet data network (PDN) gateway (GW) according to an example embodiment in which the mobile station initiates service flow establishment.

FIG. 2C is a timing diagram showing establishment of a connection between a mobile station (MS) and a packet data network (PDN) gateway (GW) according to another example embodiment.

FIG. 2D is a timing diagram showing establishment of a connection between a mobile station (MS) and a packet data network (PDN) gateway (GW) according to another example embodiment.

FIG. 3A is a block diagram showing a dynamic service addition (DSA) message according to an example embodiment.

FIG. 3B is a block diagram showing a payload included in the DSA message of FIG. 3A according to an example embodiment.

FIG. 3C is a block diagram showing a DHCP request message according to an example embodiment.

FIG. 3D is a block diagram showing an options field included in the DHCP request message shown in FIG. 3C according to an example embodiment.

FIG. 4 is a flowchart showing a method according to an example embodiment.

FIG. 5 is a flowchart showing a method according to another example embodiment.

FIG. 6 is a flowchart showing a method according to another example embodiment.

FIG. 7 is a flowchart showing a method according to another example embodiment.

FIG. 8 is a flowchart showing a method according to another example embodiment.

FIG. 9 is a flowchart showing a method according to another example embodiment.

FIG. 10 is a block diagram showing an apparatus according to an example embodiment.

### DETAILED DESCRIPTION

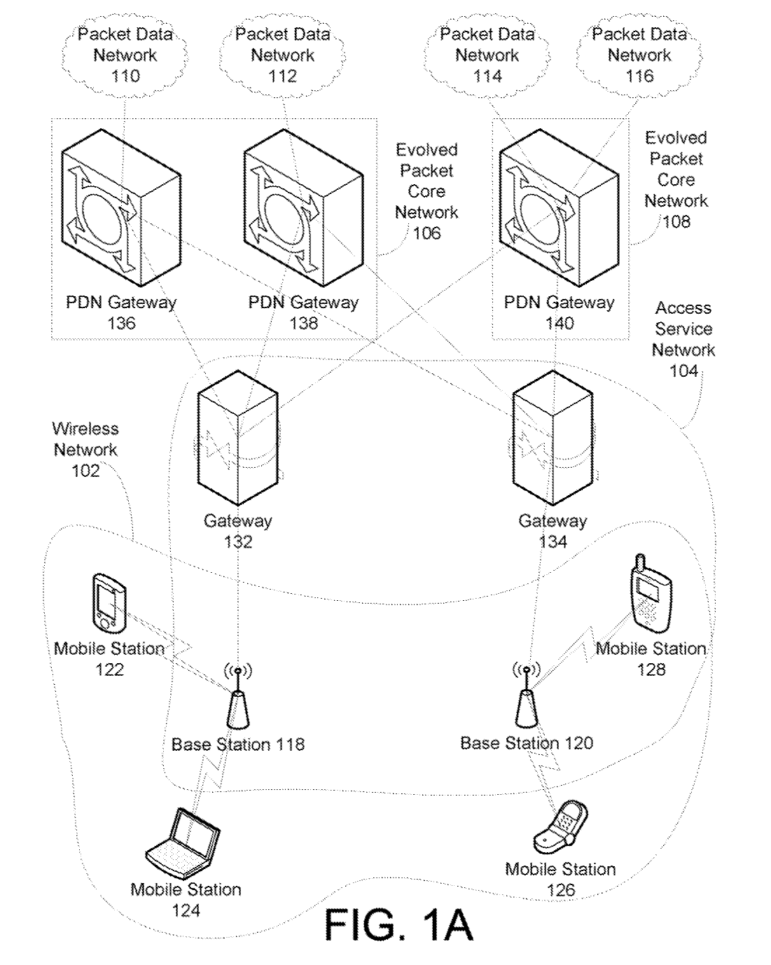

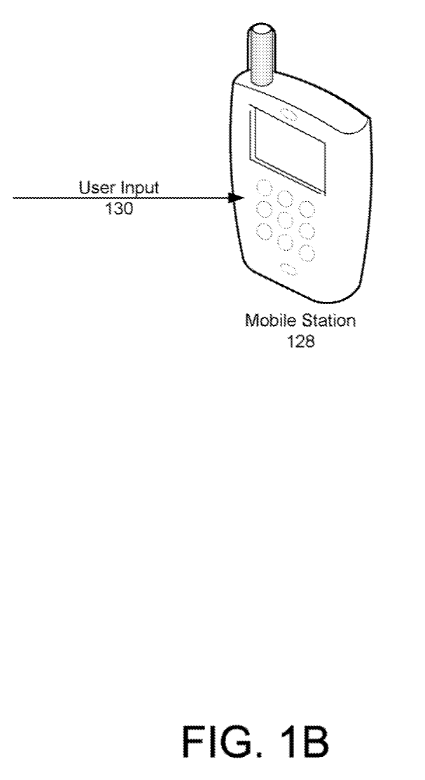

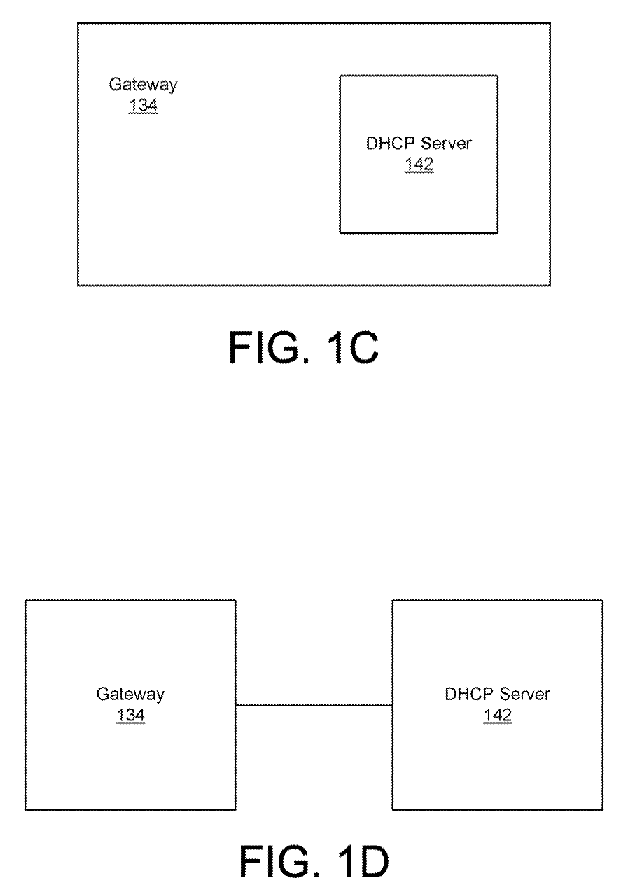

FIG. 1A is a diagram showing a wireless network 102, an access service network 104, evolved packet core networks 106, 108, and packet data networks 110, 112, 114, 116 according to an example embodiment. The wireless network 102 may include, for example, an IEEE 802.16 based Worldwide interoperability for Microwave Access (WiMAX) network.

The wireless network 102 may include one or more base stations 118, 120. The base stations 118, 120 may, for example, include WiMAX base stations. The base stations 118, 120 may be connected to the access service network (ASN) 104 via a wired or wireless connection, according to example embodiments. The ASN 104 may, for example, include a WiMAX access service network. Each of the base stations 118, 120 may serve one or more mobile stations 122, 124, 126, 128. The mobile stations 122, 124, 126, 128 may, for example, include personal digital assistants (PDAs), laptop or notebook computers, cellular telephones, or smartphones, according to example embodiments.

The base stations 118, 120 may communicate with the mobile stations 122, 124, 126, 128 via an air interface. The base stations 118, 120 may communicate with the mobile stations 122, 124, 126, 128 directly via the air interface, or may communicate with the mobile stations 122, 124, 126, 128 via one or more relay stations (not shown). The relay stations, if used, may communicate with each other and/or with the mobile stations 122, 124, 126, 128 and base stations 118, 120 via the air interface. The relay stations may forward data and/or messages between the base stations 118, 120 and the mobile stations 122, 124, 126, 128. As used in this description, when the base stations 118, 120 and mobile stations 122, 124, 126, 128 send and receive messages from each other, the messages may be sent and received directly between the base stations 118, 120 and mobile stations 122, 124, 126, 128 via the air interface, or via one or more relay stations.

When a mobile station 122, 124, 126, 128 enters the wireless network 102, the mobile station 122, 124, 126, 128 may engage in an initialization procedure with the respective base station 118, 120. The mobile station 122, 124, 126, 126, 128 may enter the wireless network 102 upon being powered on, or upon physically moving within range of the base station 118, 120, according to example embodiments. The mobile station 122, 124, 126, 128 may, for example, consult a frequency list stored in its memory, and search on one or more of the channels in the frequency list for a frame preamble transmitted by a base station 118, 120. If the mobile station 122, 124, 126, 128 finds the preamble, the mobile station 122, 124, 126, 128 may determine the base station's 118, 120 downlink transmission parameters and synchronize with the base station 118, 120.

The mobile station 122, 124, 126, 128 may also engage in initial ranging with the base station 118, 120. The mobile station 122, 124, 126, 128 may, for example, adjust its transmission timing and transmission power for communication with the base station 118, 120. The base station 118, 120 may allocate basic and primary management connection identifiers (CIDs) to the mobile station 122, 124, 126, 128.

The mobile station 122, 124, 126, 128 may also negotiate basic capabilities with the base station 118, 120. The mobile station 122, 124, 126, 128 and the base station 118, 120 may, for example, negotiate fundamental medium access control (MAC) and physical layer (PHY) features, such as maximum transmission power, modulation schemes, forward error correction (FEC) codes, and/or support of MAC bandwidth allocation schemes, according to example embodiments.

The mobile station 122, 124, 126, 128 may also authenticate itself to the base station 118, 120, such as by engaging in an authorization protocol with the base station 118, 120. The authorization protocol may, for example, include sending an authentication information privacy key management version 2 (PKMv2) message to the base station 118, 120. The mobile station 122, 124, 126, 128 may also send an authorization request message including a certificate to the base station 118, 120. The base station 118, 120 may authenticate the certificate, and the base station 118, 120 and mobile station 122, 124, 126, 128 may establish a security association (SA) and exchange traffic encryption keys.

The mobile station 122, 124, 126, 128 may register with the base station 118, 120, which may include negotiating an Internet Protocol (IP) version and quality of service parameters. The mobile station 122, 124, 126, 128 may also acquire an IP address from the base station 118, 120.

The mobile station 122, 124, 126, 128 may determine a packet data network (PDN) with which to communicate. The PDN may include, for example, the Internet, an enterprise network, such as a network operated by a user's employer or place of business, or an IP Multimedia System (IMS) network. The mobile station 122, 124, 126, 128 may determine the PDN based, for example, on receiving input from a user of the mobile station 122, 124, 126, 128. FIG. 1B is a diagram showing a mobile station 122, 124, 126, 128 receiving user input 130 according to an example embodiment. The user input may or may not directly indicate the PDN or APN. The user input 130 may indicate a desired application or task for the mobile station 122, 124, 126, 128 to perform, and the mobile station 122, 124, 126, 128 may map the application or task to a PDN or APN. An application may be preconfigured or provisioned to use a specific PDN, and an APN associated with the PDN may be preconfigured on the mobile station 122, 124, 126, 128. The user may select an application, and the mobile station 122, 124, 126, 128 may determine the APN and/or PDN based on the selected application. For example, if the user clicks on a web browser icon, the mobile station 122, 124, 126, 128 may determine that the PDN should be the Internet. If the user clicks on a corporate email icon, the mobile station 122, 124, 126, 128 may determine that the PDN should be an enterprise network. If the user clicks on a video or audio icon, the mobile station 122, 124, 126, 128 may determine that the PDN should be an IMS network.

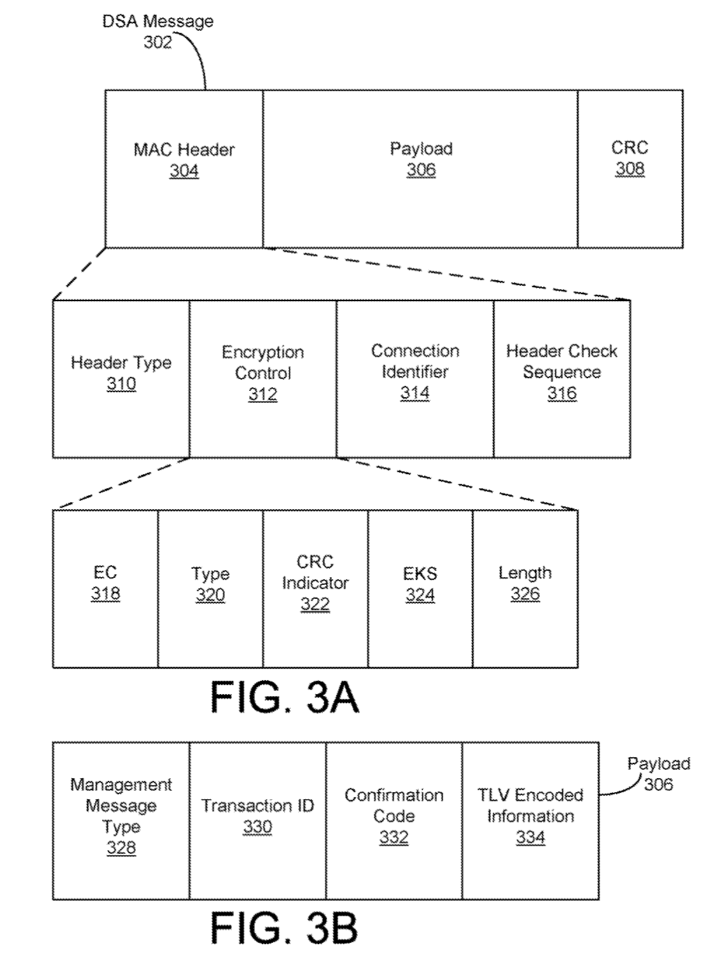

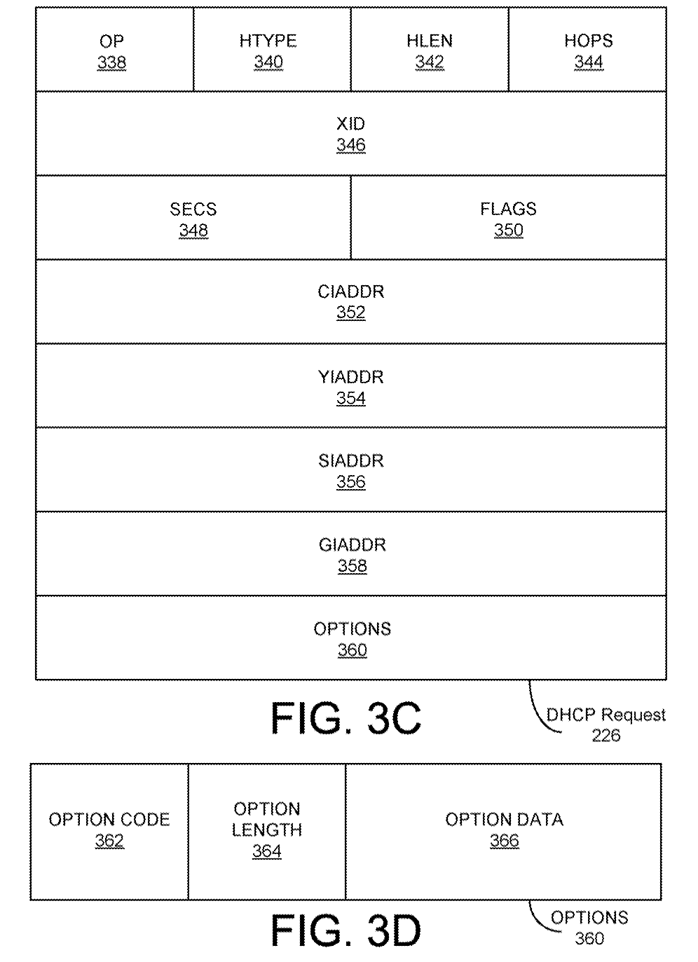

Referring back to FIG. 1A, after or during entering and initializing with the base station 118, 120, the mobile station 122, 124, 126, 128 may send a dynamic service addition (DSA) message to the base station 118, 120. The DSA message, which is described in further detail with reference to FIGS. 3A and 3B, may identify a PDN by APN. The APN may map to a PDN. The DSA message may, for example, include the PDN determined by the mobile station 122, 124, 126, 128.

The DSA message may, for example, include either a DSA request or a DSA response. In an example in which the mobile station 122, 124, 126, 128 initiates a service flow establishment, the mobile station 122, 124, 126, 128 may send a DSA request to the base station 118, 120. In response to receiving the DSA request, the base station 118, 120 may send a DSA response to the mobile station 122, 124, 126, 128 confirming and/or acknowledging the request.

In an example in which the base station 118, 120 initiates the service flow establishment, the base station 118, 120 may send a DSA request to the mobile station 122, 124, 126, 128. The DSA request may include a request for a PDN. The mobile station 122, 124, 126, 128 may, in response to receiving the DSA request, send a DSA response to the base station 118, 120. The DSA response may include the APN which identifies the PDN.

The base stations 118, 120 may be included in the access service network (ASN) 104. The ASN 104 may include a wired infrastructure network which provides data to the base stations 118, 120. The ASN may include the base stations 118, 120, as well as one or more ASN gateways 132, 134. The ASN gateways 132, 134 may each serve one or more base stations 118, 120 via a wired or wireless interface.

Upon entry of a mobile station 122, 124, 126, 128 into the wireless network 102, the serving base station 118, 120 may engage in a network entry procedure with its respective serving ASN gateway 132, 134. The serving base station 118, 120 may, for example, exchange attachment messages with its serving ASN gateway 132, 134. The serving base station 118, 120 may, for example, include context information and/or identification information for the mobile station 122, 124, 126, 128 and/or serving base station 118, 120 in an attachment message sent to the serving ASN gateway 132, 134. The serving base station 118, 120 may also authenticate the mobile station 122, 124, 126, 128 to the serving ASN gateway 132, 134 by exchanging authentication request messages with the ASN gateway 132, 134, according to an example embodiment.

In an example embodiment, the serving base station 118, 120 may establish a generic routing encapsulation (GRE) tunnel between the serving base station 118, 120 and the serving ASN gateway 132, 134. The combination of the air interface between the mobile station 122, 124, 126, 128 and the serving base station 118, 120 (which may or may not include relay stations) and the GRE tunnel between the serving base station 118, 120 and the serving ASN gateway may form a service flow between the mobile station 122, 124, 126, 128 and the serving ASN gateway 132, 134.

Establishing the GRE tunnel may include exchanging data path (DP) messages between the serving base station 118, 120 and the serving ASN gateway 132, 134. For example, the serving base station 118, 120 may send a DP message to the serving ASN gateway. The DP message may include the APN identifying the PDN that the base station 118, 120 received from the mobile station 122, 124, 126, 128.

In an example in which the mobile station 122, 124, 126, 128 initiated the exchange of DSA messages, the DP message sent by the serving base station 118, 120 may include a DP request. The base station 118, 120 may send the DP request to the serving ASN gateway 132, 134 in response to receiving the DSA request from the mobile station 122, 124, 126, 128. The serving ASN gateway 132, 134 may send a DP response to the serving base station 118, 120, thereby establishing the GRE tunnel, in response to receiving the DP request. In response to receiving the DP response from the serving ASN gateway 132, 134, the base station 118, 120 may send a DSA response to the mobile station 122, 124, 126, 128.

In an example in which the serving ASN gateway 132, 134 initiates the request, the serving ASN gateway 132, 134 may send a DP request to the serving base station 118, 120. In response to receiving the DP request from the serving ASN gateway 132, 134, the serving base station 118, 120 may send a DSA request to the mobile station 122, 124, 126, 128. The mobile station 122, 124, 126, 128 may respond to the DSA request by sending the DSA response identifying the PDN by APN to the serving base station 118, 120. In response to receiving the DSA response from the mobile station 122, 124, 126, 128, the serving base station 118, 120 may send the DP message, which may include a DP response, to the serving ASN gateway 132, thereby establishing the GRE tunnel.

The ASN gateways 132, 134 may be connected via wired and/or wireless connections to the EPC networks 106, 108, and/or to an access authentication authorization (AAA) server (not shown in FIG. 11A). During the entry and initialization of the mobile station 122, 124, 126, 128, the serving ASN gateway 132, 134 may communicate with the AAA server to authorize the mobile station 122, 124, 126, 128 to operate within the wireless network 102.

The EPC networks 106, 108 may serve as interfaces to the PDNs 110, 112, 114, 116. Each EPC network 106, 108 may include one or more PDN gateways (or access point nodes (APNs)) 136, 138, 140. Each PDN gateway 136, 138, 140 may be associated with, and serve as an interface to, one or more PDN networks 110, 112, 114, 116. Each of the ASN gateways 132, 134 may be connected to one or more PDN gateways 136, 138, 140, and thereby have access to the PDNs 110, 112, 114, 116 with which the respective PDN gateways 136, 138, 140 are associated. The ASN gateways 132, 134 may communicate with the PDN gateways 136, 138, 140 using, for example, proxy mobile Internet Protocol (IP) version 6.

The ASN gateways 132, 134 may store associations between the PDN gateways 136, 138, 140 and the PDNs 110, 112, 114, 116. Upon receiving the DP message including the APN from the serving base station 118, 120, the serving ASN gateway 132, 134 may map the APN to a PDN associated with a PDN gateway 136, 138, 140 or access point node (APN). The serving ASN gateway 132, 134 may establish a connection between the mobile station 122, 124, 126, 128 which was indicated by the base station 118, 120 and the mapped PDN gateway 136, 138, 140 or APN via the serving base station 118, 120 and the serving ASN gateway 132, 134.

In an example in which the mobile station 122, 124, 126, 128 does not identify the PDN 110, 112, 114, 116 from which it should receive service (such as by identifying the PDN 110, 112, 114, 116 by APN), the serving ASN gateway 132, 134 may determine which PDN 110, 112, 114, 116 should provide service to the mobile station 122, 124, 126, 128 based on an identity of the mobile station 122, 124, 126, 128. The identity of the mobile station 122, 124, 126, 128 may include, for example a network access identifier (NAI). In an example embodiment, the serving ASN gateway 132, 134 may store an association between identities such as NAIs and PDNs 110, 112, 114, 116. The data path message that the serving ASN gateway 132, 134 receives from the serving base station 118, 120 may include the identity, such as the NAI, of the mobile station 122, 124, 126, 128. The serving ASN gateway 132, 134 may determine which PDN 110, 112, 114, 116 should provide service to the mobile station 122, 124, 126, 128 based on the identity such as the NAI. The serving ASN gateway 132, 134 may map the determined PDN to the PDN gateway 136, 138, 140 or APN, and establish a connection between the mobile station 122, 124, 126, 128 and the PDN gateway 136, 138, 140 or APN via the serving base station 118 and the ASN gateway 132, 134, according to an example embodiment.

FIG. 1C is a diagram showing an ASN gateway 134 and a dynamic host configuration protocol (DHCP) server 142 according to an example embodiment. In this example, the DHCP server 142 may be considered a software component of the ASN gateway 134. The ASN gateway 134 and the DHCP server 142 may send and receive messages to and from each other via a wired or guided connection, according to an example embodiment.

FIG. 1D is a diagram showing an ASN gateway 134 and a DHCP server 142 according to another example embodiment. In this example, the ASN gateway 134 and the DHCP server 142 may be separate devices. The ASN gateway 134 and the DHCP server 142 may be coupled to each other and send and receive messages to and from each other via a wired or guided connection, according to an example embodiment.

In either or both of the examples shown in FIGS. 1C and 1D, the ASN gateway 134 may include a mobility access gateway (MAG) function. The MAG function may select a PDN gateway 136, 138, 140 for a mobile station 122, 124, 126, 128 to communicate with a PDN which may be identified by APN.

In either or both of the examples shown in FIGS. 1C and 1D, the DHCP server 142 may send and receive messages to and from any or all of the mobile stations 122, 124, 126, 128, such as via a base station 118, 120 and/or relay station(s). The DHCP server 142 may, for example, be coupled to one or more base stations 118, 120 via a wired or guided connection.

The DHCP server 142 may, for example, receive a DHCP request message (shown in FIG. 3C) from a mobile station 122, 124, 126, 128. The DHCP request message may identify a PDN by access point with which the mobile station 122, 124, 126, 128 may establish a connection. The DHCP server 142 may, in response to receiving the DHCP request message, send a proxy mobility access gateway Internet Protocol (PMIP) MAG trigger message to the MAG function of the ASN gateway 134. The PMIP MAG trigger message may identify a PDN by APN.

The ASN gateway 134 may, in response to receiving the PMIP MAG trigger message, determine whether the identified PDN 110, 112, 114, 116 is available to communicate with the mobile station 122, 124, 126, 128. Based on the determination, the ASN gateway 134 may send a response to the DHCP server 142, such as an acknowledgment (ACK) indicating that the identified PDN is available to communicate with the mobile station 122, 124, 126, 128, or a negative acknowledgment (NAK) indicating that the identified PDN is not available to communicate with the mobile station 122, 124, 126, 128. If the ASN gateway 134 determined that the identified PDN 110, 112, 114, 116 is available to communicate with the mobile station 122, 124, 126, 128 then the ASN gateway 134 may send a proxy binding update to the PDN gateway 136, 138, 140, and may receive a proxy binding acknowledgment from the PDN gateway 136, 138, 140. The DHCP server 142 may, in response to receiving the response from the ASN gateway 134, send a DHCP acknowledgment to the mobile station 122, 124, 126, 128, such as via a base station 118, 120 and/or relay station(s). The DHCP acknowledgment may indicate whether the identified PDN 110, 112, 114, 116 is available based on the response received from the ASN gateway 134.

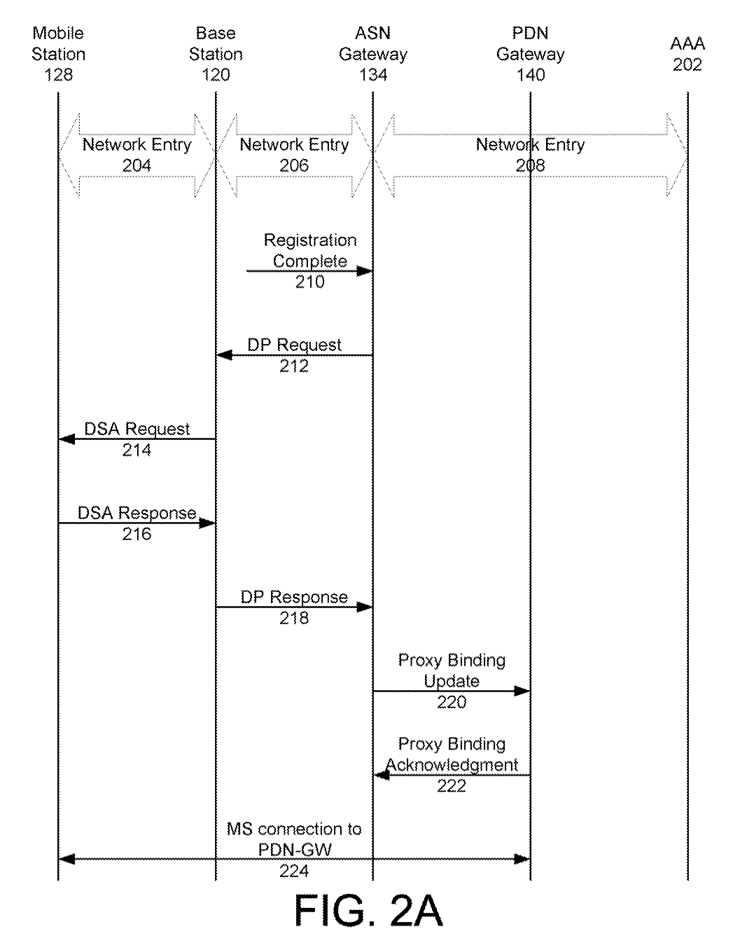

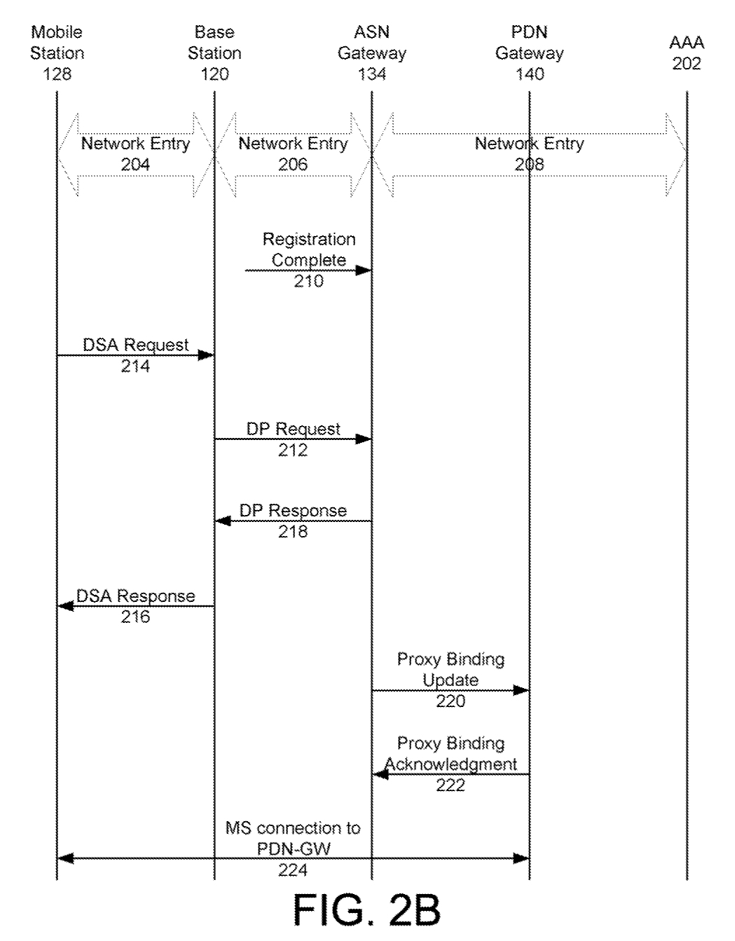

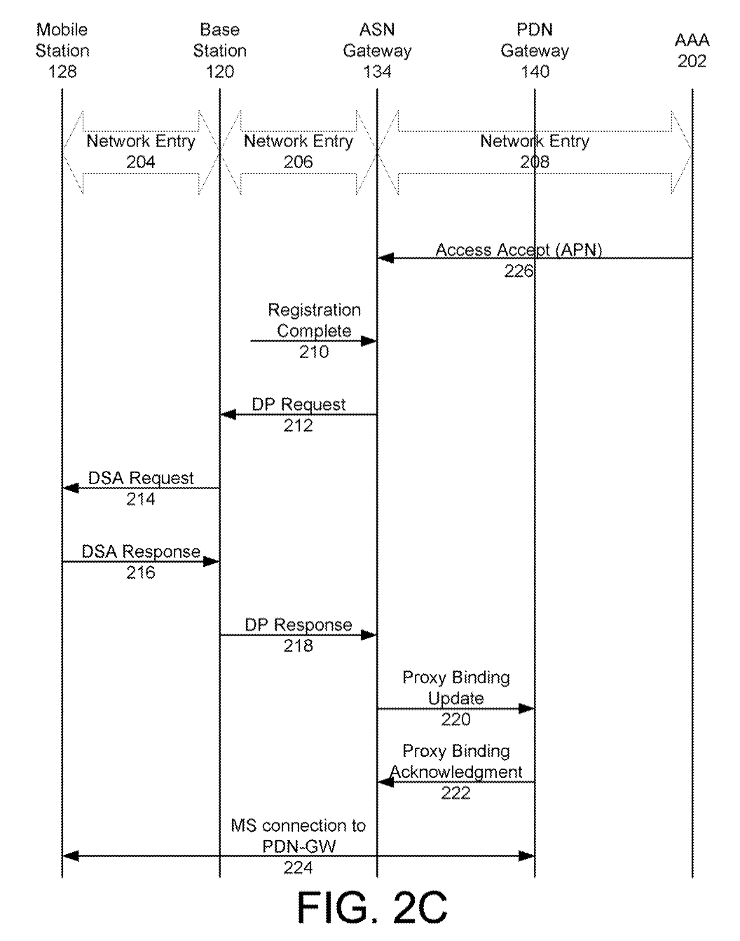

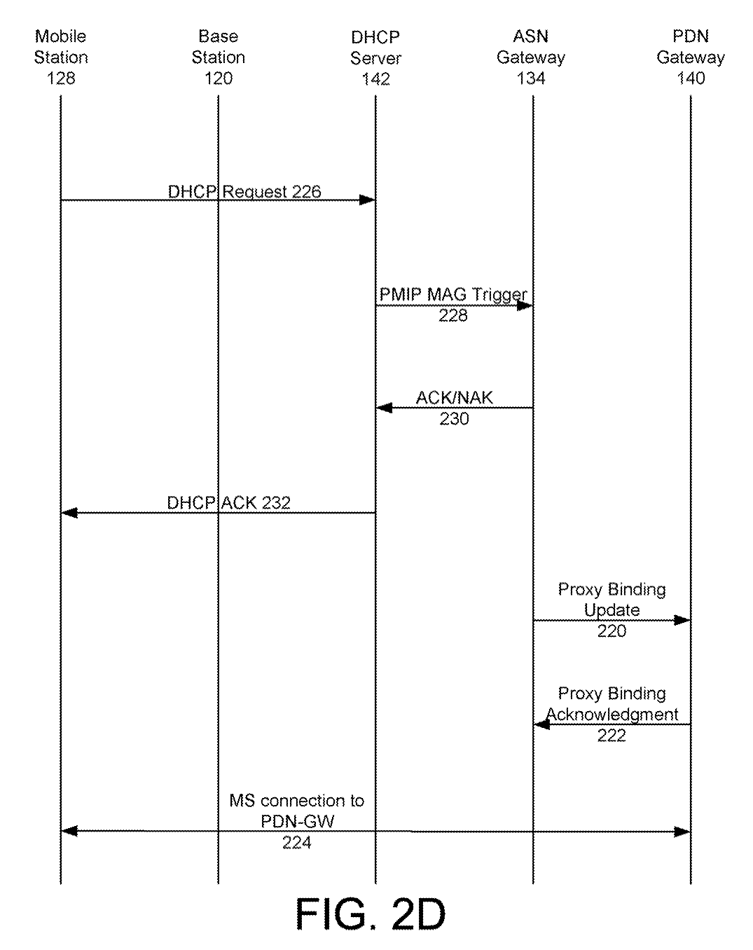

FIG. 2A is a timing diagram showing establishment of a connection between a mobile station (MS) 128 and a packet data network (PDN) gateway (GW) 140 according to an example embodiment in which the access service network 104 initiates service flow establishment. In this example, the mobile station 128 may engage in network entry (204) with the base station 120 as described in paragraphs [0033] through [0037]. Based on the mobile station's 128 network entry (204), the base station 120 may engage in network entry (206) with the ASN gateway 134 as described in paragraph [0043]. Based on the base station's 120 network entry (208), the ASN gateway 134 may engage in network entry (208) with the AAA server 202 to authenticate the mobile station 128. The registration of the mobile station 128 may then be considered complete (210).

In the example shown in FIG. 2A, in which the ASN gateway 134 may initiate the service flow establishment, the ASN gateway 134 may send a DP request 212 to the base station 120. In response to receiving the DP request 212 from the ASN gateway, the base station may send a DSA request 214 to the mobile station 128. The mobile station 128 may respond to receiving the DSA request 214 by sending a DSA response 216 to the base station 120. The DSA response 216 may include the APN as an attribute; the APN may map to the PDN with which the mobile station 128 should be associated. In response to receiving the DSA response 216 from the mobile station 128, the base station 120 may send a DP response 218 to the ASN gateway 134, establishing the GRE tunnel. The DP response may include the APN which maps to the PDN The ASN gateway 134 may map the PDN to the PDN gateway 140, and may send a proxy binding update 220 to the PDN gateway 140. The proxy binding update 220 may indicate the association between the mobile station 128 and the PDN gateway 140. In response to receiving the proxy binding update 220, the PDN gateway 140 may send a proxy binding acknowledgment 222 to the ASN gateway 134, acknowledging successful receipt of the proxy binding update 220 and confirming that the PDN gateway 140 may associate with the mobile station 128. The mobile station 128 may then be connected to the PDN gateway 140 which is identified by the APN requested by the mobile station. (224).

FIG. 2B is a timing diagram showing establishment of a connection between the mobile station (MS) 128 and the packet data network (PDN) gateway (GW) 140 according to another example embodiment in which the mobile station 128 initiates service flow establishment. In this example, the mobile station 128 may initiate the service flow establishment, and the mobile station 128 may send the DSA request 214 to the base station 120. The DSA request 214 may include the APN as an attribute; the APN may map to the PDN with which the mobile station 128 should be associated. The base station 120 may send the DP request 212 to the ASN gateway 134 in response to receiving the DSA request 214. In response receiving the DP request 212 from the base station 120, the ASN gateway 134 may send the DP response to the base station 120, establishing the GRE tunnel. The base station 120 may send the DSA response 216 to the mobile station 128 in response to receiving the DP response 218 from the ASN gateway 134.

FIG. 2C is a timing diagram showing establishment of a connection between the mobile station (MS) 128 and the packet data network (PDN) gateway (GW) 140 according to another example embodiment. In this example, the mobile station 128 may not indicate a PDN, and the ASN gateway 134 may determine a PDN to associate the mobile station 128 with a PDN based on an identity of the mobile station 128, such as the NAI of the mobile station 128. The ASN gateway 134 may determine the PDN during network entry 206, 208, and may send a message to the AAA server indicating which PDN gateway 140 or APN the mobile station 128 will be associated with, according to an example embodiment. The AAA server 202 may send an access accept (APN) message 226 accepting the APN, according to an example embodiment.

FIG. 2D is a timing diagram showing establishment of a connection between a mobile station (MS) 128 and a packet data network (PDN) gateway (GW) 140 according to another example embodiment. This example may include any or all of the network entry 204, 206, 208, registration completion 210, and/or access accept (APN message 226 described with reference to FIGS. 2A, 2B, and 2C. The mobile station 128 may have been connected to a default PDN 110, 112, 114, 116 during network entry 204, 206, 208, and may decide to attach or connect to another PDN 110, 112, 114, 116.

In the example shown in FIG. 2D, the mobile station 128 may send a DHCP request message 226 to the DHCP server 142 after the mobile station 128 has registered with the wireless network 102 and/or access service network 104. The mobile station 128 may send the DHCP request message 126 to the DHCP server 142 via the base station 120 and/or relay station(s). The DHCP request message, which is shown and described further with reference to FIGS. 3C and 3D, may identify a PDN 110, 112, 114, 116 by APN via a DHCP option. The mobile station 128 may have selected PDN 110, 112, 114, 116 and/or APN based on the user input 130 described above, according to an example embodiment.

The DHCP server 142 may receive the DHCP request message 226. In response to receiving the DHCP request message 226, the DHCP server 142 may send a trigger message to a proxy mobility Internet Protocol (PMIP) mobility access gateway (MAG) function of the ASN gateway 134. The trigger message 228 may, for example, include a proxy mobility access gateway Internet Protocol version 6 (PMIP6) MAG trigger message. The PMIP MAG trigger message 228 may include the APN.

The ASN gateway 134 may receive the trigger message 228 from the DHCP server 142. At any time after receiving the receiving the trigger message 228, the ASN gateway 134 may send a proxy binding update 220 to the PDN gateway 140, and the PDN gateway 140 may send a proxy binding acknowledgment 222 to the ASN gateway 134, as described with reference to FIG. 2A. The ASN gateway 134 may, in response to receiving the trigger message 228, send a response 230 to the DHCP server 142, such as an acknowledgment (ACK) indicating that the identified PDN 110, 112, 114, 116 is available, or a negative acknowledgment (NAK) indicating that the identified PDN 110, 112, 114, 116 is not available.

The DHCP server 142 may receive the response 230 from the ASN gateway, and based on the response 230, send a DHCP acknowledgment 232 to the mobile station 128 indicating whether the identified PDN 110, 112, 114, 116 is available. The DHCP acknowledgment 232 may have a similar format to the DHCP request message 226, shown and described with reference to FIGS. 3C and 3D. The DHCP server 142 may send the DHCP acknowledgment 232 to the mobile station 128 via a base station 120 and/or relay station. After the proxy binding acknowledgment 222 and the DHCP acknowledgment 232 have been sent, the mobile station 128 may establish a connection 224 to the PDN gateway 140, as described with reference to FIG. 2A. The mobile station 128 may thereafter exchange data with the identified PDN 110, 112, 114, 116 via the base station 120, according to an example embodiment.

FIG. 3A is a block diagram showing a dynamic service addition (DSA) message 302 according to an example embodiment. The DSA message 302 may, for example, include a DSA request 214 or a DSA response 216. The DSA message 302 may, for example, include a medium access control (MAC) header 304, a payload 306, and a cyclic redundancy check (CRC) 308. The MAC header 304 may include a header type field 310, indicating, for example, that the DSA message 302 is a generic MAC header. The MAC header 304 may also include an encryption control field 312, described in paragraph [0068], a connection identifier (CID) field 314, and a header check sequence (HCS) field 316.

The encryption control field 312 may include a encryption control (EC) subfield 318 indicating whether the payload 306 is encrypted, a type subfield 320 indicating, for example, that the payload 306 includes a PDN, a CRC indicator subfield 322 indicating whether the CRC 308 is included in the DSA message 302, an encryption key sequence (EKS) subfield 324 indicating an index of a traffic encryption key (TEK) and initialization vector used to encrypt the payload 306 if the EC subfield 318 indicated that the payload 306 is encrypted, and a length subfield 326 indicating a length of the DSA message 302.

FIG. 3B is a block diagram showing the payload 306 included in the DSA message 302 of FIG. 3A according to an example embodiment. In this example, the payload 306 may include a management message type field 328 indicating whether the DSA message 302 is a DSA request 214 or a DSA response 216. The payload 306 may also include a transaction ID field 330 indicating the transaction in which either the DSA request 214 or DSA response 216 includes the PDN. If the DSA message 302 includes a DSA response 216, the payload 306 may include a confirmation code 332 for the entire corresponding DSA request 214. The payload 306 may also include type/length/value encoded information 334, which may include the PDN.

FIG. 3C is a block diagram showing a DHCP request message 226 according to an example embodiment. The DHCP request message 226 may have been sent by the mobile station 128 to the DHCP server 142 via the base station 120, as described with reference to FIG. 2D. The DHCP acknowledgment 132 may have a similar format. While not shown in FIG. 3C, the DHCP request message 226 and/or DHCP acknowledgment 132 may also include uniform datagram protocol (UDP) header, and Internet Protocol (IP) header, and/or a medium access control (MAC) header, according to example embodiments.

The DHCP request message 226 may include an operation field 338 which may indicate whether the mobile station 128 or the DHCP server 142 sent the message. For example, the operation field 338 may be set to 1 for a DHCP request message 226 sent by the mobile station 128 to the DHCP server 142, and to 2 for a DHCP acknowledgment 232 sent by the DHCP server 142 to the mobile station 128.

The DHCP request message 226 may also include an htype field 340 indicating a link-layer address type. The DHCP request message 226 may also include an hlen field 342 indicating a link-layer address length, such as in bytes. The DHCP request message 226 may also include an hops field 344 which may indicate a number of relay agents which forwarded the DHCP request message 226. In an example embodiment, each of the operation field 338, htype field 340, hlen field 342, and hops field 344 may be eight bits long.

The DHCP request message 226 may also include an xid field 346 or transaction identifier. The xid field 346 may, for example, be used by the mobile station 128 to match responses from the DHCP server 142 with requests previously transmitted by the mobile station 128.

The DHCP request message 226 may also include a secs field 348. The secs field 348 may indicate the elapsed time, such as in seconds, since the mobile station 128 began the DHCP process. The DHCP request message 226 may also include a flags field 350. The flags field 350 may indicate whether messages to the mobile station 128 should be broadcast. In an example embodiment, the secs field 348 and the flags field 350 may each be sixteen bits long.

The DHCP request message 226 may also include a ciadder field 352. The ciaddr field 352 may include the mobile station's 128 Internet Protocol (IP) address. The ciaddr field 352 may be set by the mobile station 128 after the mobile station 128 has confirmed that the mobile station's 128 IP address is valid.

The DHCP request message 226 may also include a yiaddr field 354. The yiaddr field may include the mobile station's IP address. The yiaddr field may be set by the DHCP server 142 to inform the mobile station 128 of the mobile station's 128 IP address.

The DHCP request message 226 may also include a siaddr field 356. The siaddr field 356 may include an IP address for a next server for the mobile station 128 to use, such as the DHCP server 142. The mobile station 128 may have learned the DHCP server's 142 IP address during a service flow, according to an example embodiment.

The DHCP request message 226 may also include a giaddr field 358. The giaddr field 358 may include an IP address of a relay agent through which the DHCP request 226 or DHCP acknowledgment 232 was received.

The DHCP request message 226 may also include an options field 360. FIG. 3D is a block diagram showing the options field 360 included in the DHCP request message 226 shown in FIG. 3C according to an example embodiment. The options field 360 may include an option code subfield 362. The option code subfield 362 may identify the DHCP request message 226 and/or options field 360 as an APN option which identifies a requested PDN by APN. The options field 360 may also include an option length subfield 364 indicating the length of the following subfield, the option data subfield 366. The option data subfield 366 may identify the PDN by APN, according to an example embodiment.

In an example embodiment, the xid field 346, the ciaddr field 352, the yiaddr field 354, the siaddr field 356 the giaddr field 358, and the options field 360 may each be thirty-two bits long.

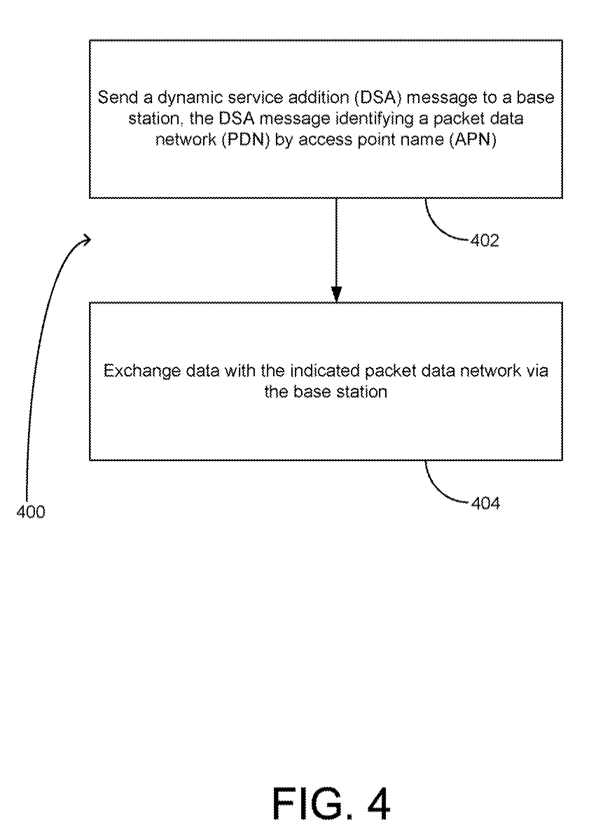

FIG. 4 is a flowchart showing a method 400 according to an example embodiment. In this example, the method 400 may include sending, by a mobile station in a wireless network, a dynamic service addition (DSA) message to a base station, the DSA message identifying a packet data network (PDN) by access point name (APN) (402). The method 400 may also include exchanging data with the indicated packet data network via the base station (404).

In an example embodiment, the sending (402) may include sending, by the mobile station in a Worldwide interoperability for Microwave Access (WiMAX) network, the dynamic service addition message to the base station.

In an example embodiment, the method 400 may further include entering the wireless network. The entering may including synchronizing with the base station, establishing transmission timing and transmission power for communication with the base station, negotiating modulation schemes with the base station, authenticating the mobile station to the base station, registering the mobile station with the base station, and acquiring an Internet Protocol (IP) address from the base station.

In an example embodiment, the sending (402) may include sending, by the mobile station in the wireless network, the DSA message to the base station, the DSA message including a DSA request, the DSA request including a medium access control (MAC) header, a payload including the APN, and a cyclic redundancy check (CRC).

In an example embodiment, the sending (402) may include sending the DSA message from the mobile station to the base station in response to receiving a DSA request from the base station, the DSA message including a DSA response, the DSA response including a medium access control (MAC) header, a payload including the APN, and a cyclic redundancy check (CRC).

In an example embodiment, the sending (402) may include sending, by the mobile station in the wireless network, the DSA message to the base station, the DSA message including a medium access control (MAC) header, a payload including a management message type field identifying the DSA message as either a DSA request or a DSA response, a transaction ID field identifying a transaction which includes the DSA message, and the APN, and a cyclic redundancy check (CRC).

In an example embodiment, the method 400 may further include receiving input from a user, and determining the APN based on the input.

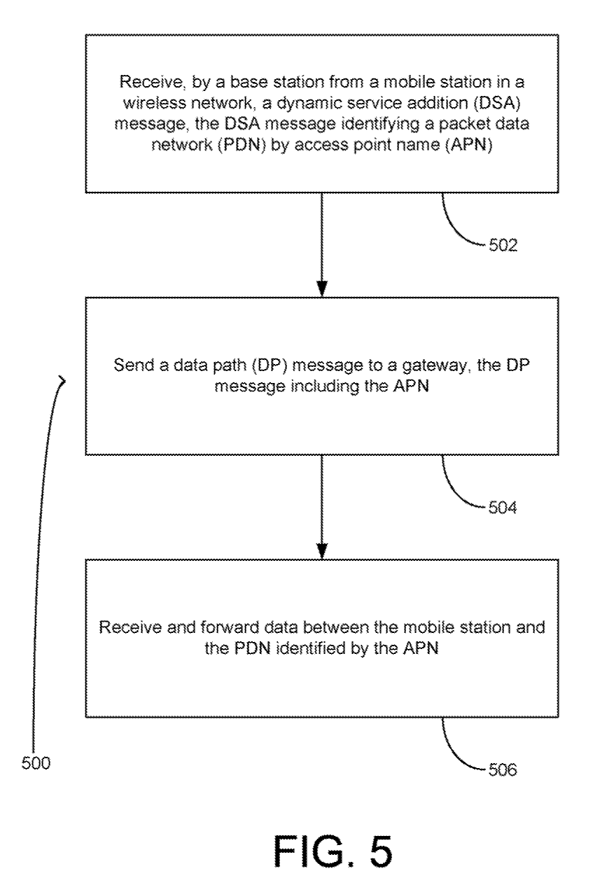

FIG. 5 is a flowchart showing a method 500 according to another example embodiment. In this example, the method 500 may include receiving, by a base station from a mobile station in a wireless network, a dynamic service addition (DSA) message, the DSA message identifying a packet data network (PDN) by access point name (APN) (502). The method 500 may also include sending a data path (DP) message to a gateway, the DP message including the APN (504). The method 500 may also include receiving and forwarding data between the mobile station and the PDN identified by the APN (506).

In an example embodiment, the receiving and forwarding the data (506) may include receiving and forwarding the data between the mobile station and the identified PDN via the gateway.

In an example embodiment, the method 500 may further include initializing the mobile station. The initializing may including allocating at least one connection identifier (CID) to the mobile station, negotiating at least one modulation scheme with the mobile station, authorizing the mobile station to operate in the wireless network, registering the mobile station in the wireless network, and assigning an Internet Protocol (IP) message to the mobile station.

In an example embodiment, the receiving the DSA message (502) may include receiving a DSA request from the mobile station, the DSA request identifying the PDN by the APN. In this example, the method 500 may further include, in response to receiving the DSA request from the mobile station, sending a data path (DP) request to the gateway, the DP request including the APN. The method 500 may further include receiving a DP response from the gateway. The method 500 may further include, in response to receiving the DP response from the gateway, sending a DSA response to the mobile station.

In an example embodiment, the receiving the DSA message (502) may include receiving a DSA response from the mobile station, the DSA response identifying the PDN by the APN. In this example, the method 500 may further include receiving a data path (DP) request from the gateway. The method 500 may further include, in response to receiving the DP request from the gateway, sending a DSA request to the mobile station. The method 500 may further include, in response to receiving the DSA response from the mobile station, sending a DP response to the gateway, the DP response including the APN.

In an example embodiment, the method 500 may further include establishing a Generic Routing Encapsulation (GRE) tunnel with the gateway.

In an example embodiment, the receiving (502) may include receiving, by the base station in the wireless network, the DSA message from the mobile station, the DSA message including a DSA request, the DSA request including a medium access control (MAC) header, a payload including the APN, and a cyclic redundancy check (CRC).

In an example embodiment, the receiving (502) may include receiving, by the base station in the wireless network, the DSA message from the mobile station, the DSA message including a DSA response, the DSA response including a medium access control (MAC) header, a payload including the APN, and a cyclic redundancy check (CRC).

In an example embodiment, the receiving (502) may include receiving, by the base station in the wireless network, the DSA message from the mobile station. In this example, the DSA message may include a medium access control (MAC) header, a payload including a management message type field identifying the DSA message as either a DSA request or a DSA response, a transaction ID field identifying a transaction which includes the DSA message, and the APN, and a cyclic redundancy check (CRC).

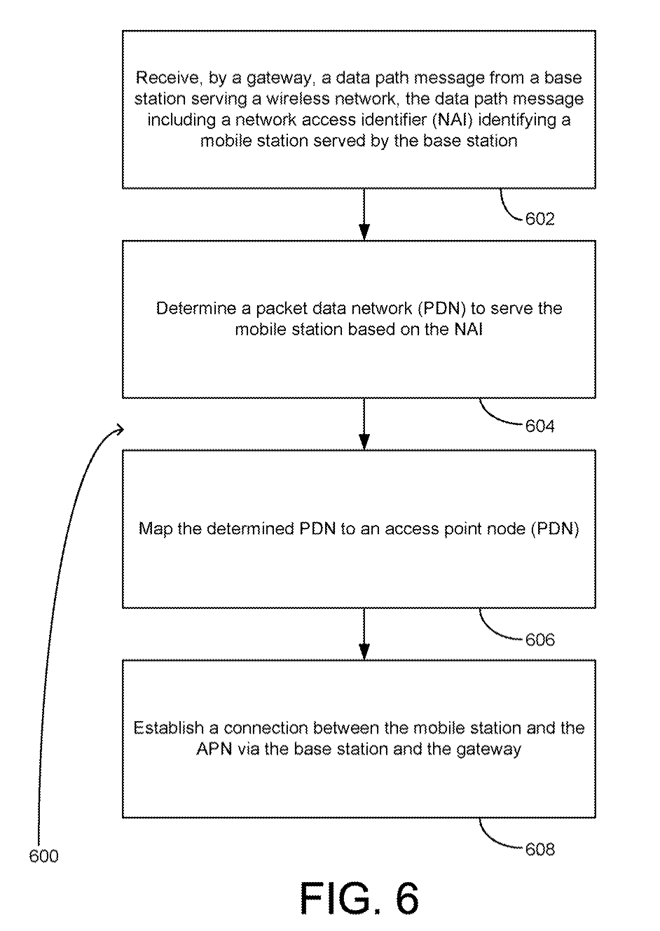

FIG. 6 is a flowchart showing a method 600 according to another example embodiment. In an example embodiment, the method 600 may include receiving, by a gateway, a data path message from a base station serving a wireless network, the data path message including a network access identifier (NAI) identifying a mobile station served by the base station (602). The method 600 may further include determining a packet data network (PDN) to serve the mobile station based on the NAI (604). The method 600 may further include mapping the determined PDN to an access point node (APN) (606). The method 600 may further include establishing a connection between the mobile station and the APN via the base station and the gateway (608).

In an example embodiment, the receiving (602) may include receiving, by the gateway, the data path message from the base station, the base station including a Worldwide interoperability for Microwave Access (WiMAX) base station serving a WiMAX network.

In an example embodiment, the determining (604) may include determining the PDN to serve the mobile station based on the NAI, the PDN including an Internet.

In an example embodiment, the determining (604) may include determining the PDN to serve the mobile station based on the NAI, the PDN including an enterprise network.

In an example embodiment, the determining (604) may include determining the PDN to serve the mobile station based on the NAI, the PDN including an Internet Protocol Multimedia System (IMS) network.

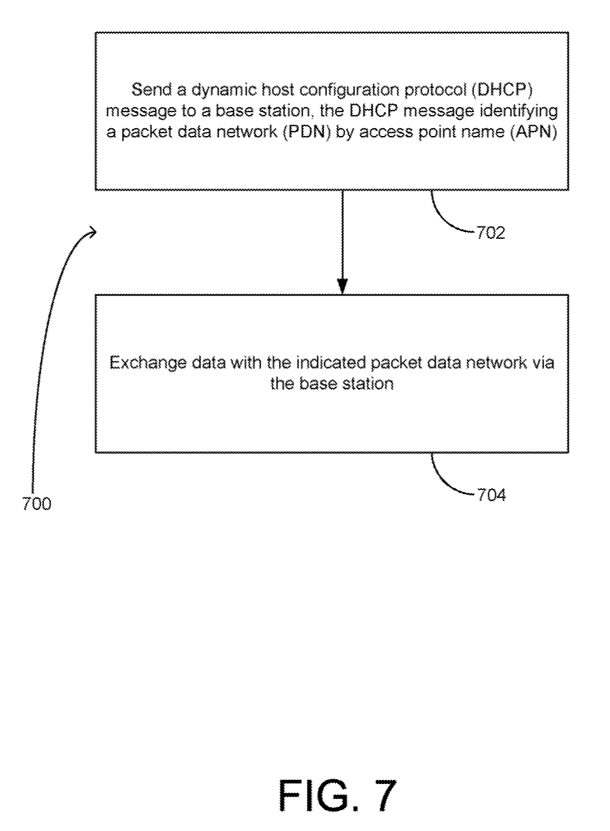

FIG. 7 is a flowchart showing a method 700 according to another example embodiment. In an example embodiment, the method 700 may include sending, by a mobile station in a wireless network, a dynamic host configuration protocol (DHCP) message to a DHCP server via a base station, the DHCP message identifying a packet data network (PDN) by access point node (APN) (702). The method 700 may also include exchanging data with the indicated packet data network via the base station (704).

In an example embodiment, the sending (702) may include sending, by the mobile station in a Worldwide interoperability for Microwave Access (WiMAX) network, the DHCP message to the DHCP server via the base station.

In an example embodiment, the sending (702) may include sending, by the mobile station in a Worldwide interoperability for Microwave Access (WiMAX) network, the DHCP message to the DHCP server via the base station and an access service network (ASN) gateway.

In an example embodiment, the sending (702) may include sending, by the mobile station in a Worldwide interoperability for Microwave Access (WiMAX) network, the DHCP message to the DHCP server via the base station, the DHCP server being included in an access service network (ASN) gateway.

In an example embodiment, the method may further include entering the wireless network. The entering may include synchronizing with the base station, establishing transmission timing and transmission power for communication with the base station, negotiating modulation schemes with the base station, authenticating the mobile station to the base station, registering the mobile station with the base station, and acquiring an Internet Protocol (IP) address from the base station.

In an example embodiment, the sending (702) may include sending, by the mobile station in the wireless network, the DHCP message to the base station, the DHCP message including a DHCP request, the DHCP request including an operation code indicating the DHCP request is sent by the mobile station, an option code field indicating that the DHCP request identifies the PDN by APN, and an option field identifying the PDN by APN.

In an example embodiment, the method 700 may further include receiving input from a user, and determining the APN based on the input.

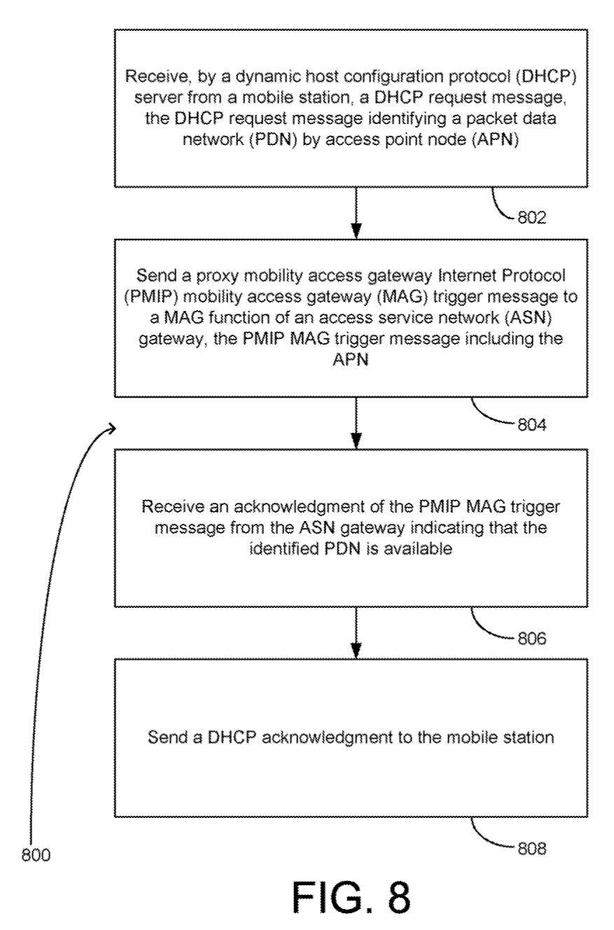

FIG. 8 is a flowchart showing a method 800 according to another example embodiment. According to this example, the method 800 may include receiving, by a dynamic host configuration protocol (DHCP) server from a mobile station, a DHCP request message, the DHCP request message identifying a packet data network (PDN) by access point node (APN) (802). The method 800 may further include sending a proxy mobility access gateway Internet Protocol (PMIP) mobility access gateway (MAG) trigger message to a MAG function of an access service network (ASN) gateway, the PMIP MAG trigger message including the APN (804). The method 800 may further include receiving an acknowledgment of the PMIP MAG trigger message from the ASN gateway indicating that the identified PDN is available (806). The method 800 may further include sending a DHCP acknowledgment to the mobile station (808).

In an example embodiment, the receiving the DHCP request message from the mobile station (802) may include receiving the DHCP request message from the mobile station via a Worldwide interoperability for Microwave Access (WiMAX) base station. In this example, the sending the DHCP acknowledgement to the mobile station (808) may include sending the DHCP acknowledgment to the mobile station via the Worldwide interoperability for Microwave Access (WiMAX) base station.

In an example embodiment, the sending the PMIP MAG trigger message to the MAG function of the ASN gateway (804) may include sending a proxy mobility Internet Protocol version 6 (PMIP6) MAG trigger message to the MAG function of the ASN gateway. In this example, the receiving the acknowledgment of the PMIP MAG trigger message from the ASN gateway (806) may include receiving an acknowledgment of the PMIP6 MAG trigger message from the ASN gateway.

In an example embodiment, DHCP server may be included in the ASN gateway.

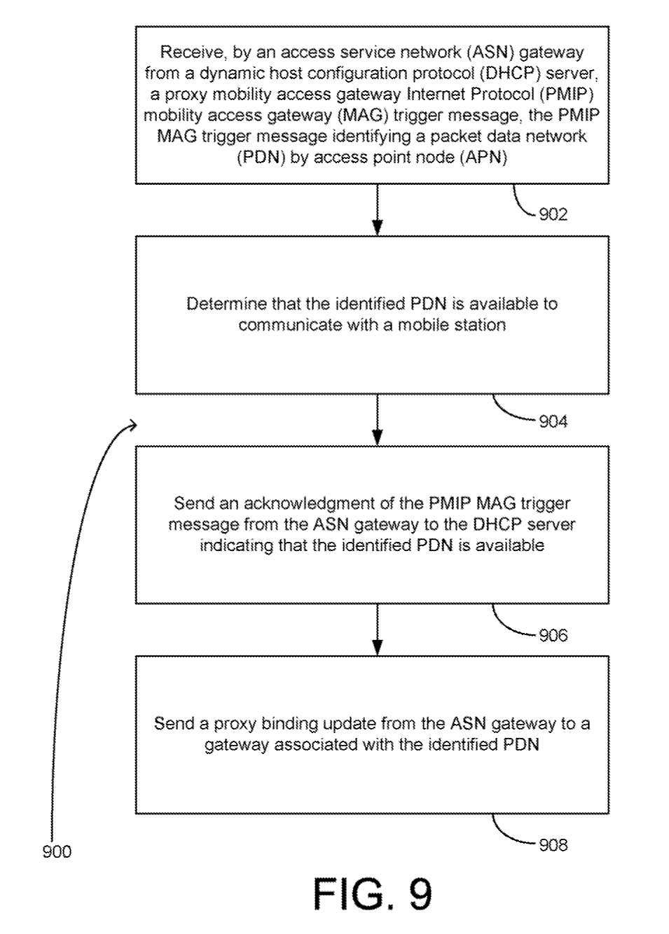

FIG. 9 is a flowchart showing a method 900 according to another example embodiment. In this example, the method 900 may include receiving, by an access service network (ASN) gateway from a dynamic host configuration protocol (DHCP) server, a proxy mobility access gateway Internet Protocol (PMIP) mobility access gateway (MAG) trigger message (902). The PMIP MAG trigger message may identify a packet data network (PDN) by access point node (APN). The method 900 may also include determining that the identified PDN is available to communicate with a mobile station (904). The method 900 may also include sending an acknowledgment of the PMIP MAG trigger message from the ASN gateway to the DHCP server indicating that the identified PDN is available (906). The method 900 may also include sending a proxy binding update from the ASN gateway to a gateway associated with the identified PDN (908).

In an example embodiment, the receiving the PMIP MAG trigger message (902) may include receiving a proxy mobility Internet Protocol version 6 (PMIP6) MAG trigger message. In this example, the sending the acknowledgment (906) may include sending an acknowledgment of the PMIP6 MAG trigger message from the ASN gateway to the DHCP server.

In an example embodiment, the DHCP server may be included in the ASN gateway.

In an example embodiment, the method 900 may further include receiving an acknowledgment of the proxy binding update from the gateway associated with the identified PDN.

In an example embodiment, the method 900 may further include establishing a connection between a mobile station and the APN via a base station and the ASN gateway.

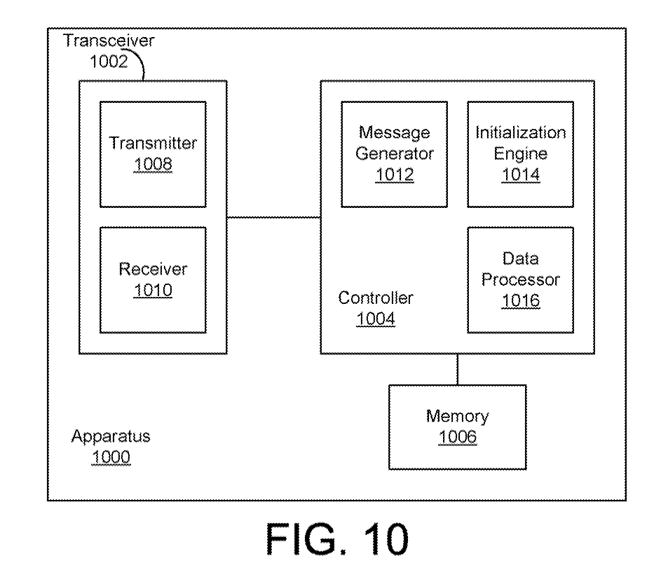

FIG. 10 is a block diagram showing an apparatus 1000 according to an example embodiment. The apparatus 1000 may include, for example, a mobile station 122, 124, 126, 128, a base station 118, 120, an ASN gateway 132, 134, or a DHCP server 142, which may perform any or all of the functions described above. In this example, the apparatus 1000 may include a transceiver 1002, a controller 1004, and a memory 1006. The transceiver 1002, which may include a transmitter 1008 and/or receiver 1010 as separate components or included in a single device, may transmit and/or receive messages via a wired or wireless interface. The controller 1004 may include a message generator 1012 configured to generate any or all of the messages described above, an initialization engine 1014 configured to perform any or all of the network entry or initialization processes described above, and/or a data processor 1016 configured to process data and/or make determinations as described above. The memory 1006 may store information and/or data as described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
sending, by a mobile station in a wireless network, a dynamic host configuration protocol (DHCP) message to a DHCP server via a base station, the DHCP message identifying a packet data network (PDN) by access point node (APN); and
exchanging data with the indicated packet data network via the base station.

2. The method of claim 1, wherein the sending includes sending, by the mobile station in the wireless network, the DHCP message to the DHCP server via the base station, the DHCP message identifying the PDN by APN and including an APN option.

3. The method of claim 1, wherein the sending includes sending, by the mobile station in a Worldwide interoperability for Microwave Access (WiMAX) network, the DHCP message to the DHCP server via the base station.

4. The method of claim 1, wherein the sending includes sending, by the mobile station in a Worldwide interoperability for Microwave Access (WiMAX) network, the DHCP message to the DHCP server via the base station and an access service network (ASN) gateway.

5. The method of claim 1, wherein the sending includes sending, by the mobile station in a Worldwide interoperability for Microwave Access (WiMAX) network, the DHCP message to the DHCP server via the base station, the DHCP server being included in an access service network (ASN) gateway.

6. The method of claim 1, wherein the method further includes entering the wireless network, the entering including:
synchronizing with the base station;
establishing transmission timing and transmission power for communication with the base station;
negotiating modulation schemes with the base station;
authenticating the mobile station to the base station;
registering the mobile station with the base station; and
acquiring an Internet Protocol (IP) address from the base station.

7. The method of claim 1, wherein the sending includes sending, by the mobile station in the wireless network, the DHCP message to the base station, the DHCP message including a DHCP request, the DHCP request including an operation code indicating the DHCP request is sent by the mobile station, an option code field indicating that the DHCP request identifies the PDN by APN, and an option field identifying the PDN by APN.

8. The method of claim 1, further comprising:
receiving input from a user; and
determining the APN based on the input.

9. An apparatus comprising:
a controller configured to:
generate a dynamic host configuration protocol (DHCP) message, the DHCP message identifying a packet data network (PDN) by access point node (APN); and
process data to be exchanged with the indicated packet data network via a base station;
a wireless transceiver configured to send the DHCP message to the base station and to send and receive the data to and from the base station; and
a memory.

10. The apparatus of claim 9, wherein the transceiver is configured to send the DHCP message to the base station, the base station including a Worldwide interoperability for Microwave Access (WiMAX) base station.

11. The apparatus of claim 9, wherein the processor is further to perform initialization upon entering the wireless network, the initialization including:
synchronize with the base station based on a frame preamble received by the transceiver from the base station;
establish transmission timing and transmission power for communication with the base station;
negotiate modulation schemes with the base station;
authenticate the mobile station to the base station;
register the mobile station with the base station; and
acquire an Internet Protocol (IP) address from the base station.

12. The apparatus of claim 9, wherein the controller is configured to generate the DHCP message, the DHCP message including a DHCP request, the DHCP request including an operation code indicating the DHCP request is sent by the mobile station, an option code field indicating that the DHCP request identifies the PDN by APN, and an option field identifying the PDN by APN.

13. The apparatus of claim 9, further comprising:
an input configured to receive input from a user
wherein the processor is configured to determine the APN based on the input.

14. A method comprising:
receiving, by a dynamic host configuration protocol (DHCP) server from a mobile station, a DHCP request message, the DHCP request message identifying a packet data network (PDN) by access point node (APN);
sending a trigger message to a proxy mobile Internet Protocol (PMIP) mobility access gateway (MAG) function, the trigger message including the APN;
receiving an acknowledgment from the PMIP MAG function indicating that the identified PDN is available; and
sending a DHCP acknowledgment to the mobile station.

15. The method of claim 14, wherein:
receiving the DHCP request message from the mobile station includes receiving the DHCP request message from the mobile station via a base station; and
the sending the DHCP acknowledgement to the mobile station includes sending the DHCP acknowledgment to the mobile station via the base station.

16. The method of claim 14, wherein:
receiving the DHCP request message from the mobile station includes receiving the DHCP request message from the mobile station via a Worldwide interoperability for Microwave Access (WiMAX) base station; and
the sending the DHCP acknowledgement to the mobile station includes sending the DHCP acknowledgment to the mobile station via the Worldwide interoperability for Microwave Access (WiMAX) base station.

17. The method of claim 14, wherein:
the sending the PMIP MAG trigger message to the MAG function of the ASN gateway includes sending a proxy mobility Internet Protocol version 6 (PMIP6) MAG trigger message to the MAG function of the ASN gateway; and
receiving the acknowledgment of the PMIP MAG trigger message from the ASN gateway includes receiving an acknowledgment of the PMIP6 MAG trigger message from the ASN gateway.

18. The method of claim 14, wherein the DHCP server is included in the ASN gateway.

19. An apparatus comprising:
a transceiver configured to send and receive messages;
a controller configured to:
process a dynamic host configuration protocol (DHCP) request message received via the transceiver, the DHCP request message identifying a packet data network (PDN) by access point node (APN);
generate a proxy mobility access gateway Internet Protocol (PMIP) mobility access gateway (MAG) trigger message for the transceiver to send to a MAG function of an access service network (ASN) gateway, the PMIP MAG trigger message including the APN;
process an acknowledgment of the PMIP MAG trigger message received by the transceiver from the ASN gateway indicating that the identified PDN is available; and
generate a DHCP acknowledgment for the transceiver to send to the mobile station; and
a memory.

20. A method comprising:
receiving, by an access service network (ASN) gateway from a dynamic host configuration protocol (DHCP) server, a proxy mobility access gateway Internet Protocol (PMIP) mobility access gateway (MAG) trigger message, the PMIP MAG trigger message identifying a packet data network (PDN) by access point node (APN);
determining that the identified PDN is available to communicate with a mobile station;
sending an acknowledgment of the PMIP MAG trigger message from the ASN gateway to the DHCP server indicating that the identified PDN is available; and
sending a proxy binding update from the ASN gateway to a gateway associated with the identified PDN.

21. The method of claim 20, wherein:
the receiving the PMIP MAG trigger message includes receiving a proxy mobility Internet Protocol version 6 (PMIP6) MAG trigger message; and
sending the acknowledgment includes sending an acknowledgment of the PMIP6 MAG trigger message from the ASN gateway to the DHCP server.

22. The method of claim 20, wherein the DHCP server is included in the ASN gateway.

23. The method of claim 20, further comprising receiving an acknowledgment of the proxy binding update from the gateway associated with the identified PDN.

24. The method of claim 20, further comprising establishing a connection between a mobile station and the APN via a base station and the ASN gateway.

25. An apparatus comprising:
a transceiver configured to send and receive data;
a controller configured to:
process a proxy mobility access gateway Internet Protocol (PMIP) mobility access gateway (MAG) trigger message received via the transceiver from a dynamic host configuration protocol (DHCP) server, the PMIP MAG trigger message identifying a packet data network (PDN) by access point node (APN);
determining that the identified PDN is available to communicate with a mobile station;
generate an acknowledgment of the PMIP MAG trigger message for the transceiver to send to the DHCP server indicating that the identified PDN is available; and
generate a proxy binding update for the transceiver to send to a gateway associated with the identified PDN; and
a memory.
